(19) United States
(12) Patent Application Publication
(10) Pub. No.: US 2007/0033827 A1
(43) Pub. Date: Feb. 15, 2007

(54) Apparatus for moving up and down a wafer cassette and chip sorter having the apparatus

(76) Inventor: Young Min Kim, Paju-si (KR)

Correspondence Address: FLESHNER & KIM, LLP, P.O. BOX 221200, CHANTILLY, VA, 20153, US

(21) Appl. No.: 11/492,208

(22) Filed: Jul. 25, 2006

(30) Foreign Application Priority Data
Jul. 28, 2005 (KR) P2005-0068925
Jul. 28, 2005 (KR) P2005-0068927

(51) Int. Cl. F26B 5/04

(52) U.S. Cl. 34/406

(57) ABSTRACT

Provided is a chip sorter including a working table on which a wafer is put; X and Y driving units horizontally moving the working table at a predetermined position, a wafer cassette elevating apparatus provided to be positioned under a working area of the working table to move up and down a cassette containing the wafer, a wafer transferring unit transferring the wafer from the cassette to the working table; and a carrier containing a chip transferred from the working table, and a picker transferring the chip from the working table to the carrier. The position of the working table over the cassette of the cassette elevating apparatus can largely reduce the size of the chip sorter.

### BACKGROUND OF THE INVENTION

1. Field of the Invention

The present invention relates to a chip sorter and more particularly to a chip sorter for separating a wafer into individual chips and transferring the individual chips to a tray or a carrier.

2. Description of the Background Art

Wafer fabrication, the devices or integrated circuits are actually formed in and on the wafer surface. Up to several thousand identical devices can be formed on each wafer, although two to three hundred is a more common number. The area on the wafer occupied by each discrete device or integrated circuit is called a chip or die. Following wafer fabrication, the devices or circuits on the wafer are complete, but untested and still in wafer form. Next comes an electrical test (called wafer sort) of every chip to identify those that meet customer specifications. Wafer sort may be the last step in the wafer fabrication or the first step in the packaging process. Packaging is the series of processes that separate the wafer into individual chips and place them into protective packages.

FIGS. 1 and 2 are top and lateral views of a conventional chip sorter for separating a wafer into individual chips and transferring the individual chips to a tray.

The conventional chip sorter includes a body 1, a cassette elevating apparatus 2 provided on one side of the body 1, a working table 3 on which to put a wafer “W” transferred from a cassette C, and a tray 4 containing a chip separated from the wafer “W”.

A picker 5, which absorbs the chip in wafer form and transfers the chip to the tray 4, is provided to be positioned above the working table 3. A wafer transferring unit 6, which transfers the wafer “W” from the cassette to the working table 3 is provided to one side of the body 1.

The working table 3 is horizontally moved by X and Y driving units (not shown) to move the chip in wafer form and position the chip under the picker 5. An area where the table can be moved farthest in the X and Y directions is defined as a working area. The working area “A” is indicated as a dotted line in FIG. 1

The cassette elevating unit 2 includes an elevating plate 2a, a fixing plate 2b to which a motor is fixed, a nut 2d which is rotatably provided to the fixing plate 2b and is connected to the motor 2c with the belt 2f for rotation, and a ball screw 2e which passes through the nut 2d and of which a top is fixed to the elevating plate 2a.

When the motor 2c rotates the nut 2d, the rotation of the nut 2d enables the ball screw 2e to be moved up and down and thereby the cassette “C” is moved up and down.

The operation of the conventional chip sorter having the above configuration is now described.

When the cassette “C” containing the wafers is properly put on the elevating plate 2a of the cassette elevating unit 2, the wafer transferring unit 6 picks out the wafer from the cassette “C” and properly put the wafer on the working table 3. The picker 5 absorbs the chip in wafer form on the working table 3, transfers the chip to tray 4, and returns to its original position. At this point, the X and Y driving units (now shown) horizontally moves a working table 3 by a length of the chip so that the next chip is placed just under the picker 5. The picker 5 absorbs the next chip in wafer form and transfer the chip to the tray 4.

The working table 3 and the picker 5 repeat the above operation until they finish transferring all the chips in wafer form to the tray. When finishing transferring all the chips in wafer form to the tray, the cassette elevating unit 2 moves up the cassette “C” by one pitch size of teeth to position a next wafer at a location from which the wafer transferring unit 6 can transfer the next wafer to the working table 3. Then, the wafer transferring unit 6 transfer the wafer to the working table 3, and the chip in wafer form, as above described, is transferred to the tray.

However, problems with the conventional chip sorter are as follows. The cassette elevating unit with which the conventional chip sorter is equipped moves up and down the cassette by moving up and down the long ball screw. Thus, the length of the ball screw has to be increased in proportion to a distance which the cassette has to travel to correspond to an increase in the height of the cassette. The increase in the length of the ball screw requires space below the body necessary for the ball screw to move. This makes it necessary to increase the height of the body, i.e., the height of the chip sorter.

The structural feature of the cassette elevating unit prevents the cassette elevating unit from being provided to be positioned under the working area “A” of the working table from being secured. Thus, in the conventional chip sorter, the cassette elevating unit has to be provided adjacent to the working area “A” of the working table to prevent the working table and the elevating unit from interfering with each other. This configuration inevitably increases a whole size of the chip sorter.

### BRIEF DESCRIPTION OF THE INVENTION

Therefore, an object of the present invention is to a wafer cassette elevating apparatus capable of reducing a size of and simplifying a structure of a machine which performs a wafer fabrication or packaging process employing the apparatus and a chip sorter having the apparatus.

Another abject of the present invention is to speed up an upward and downward movement of a wafer cassette elevating apparatus, thus improving productivity.

According to an aspect of the present invention, there is provided a wafer cassette elevating apparatus, including a base, a movable unit provided to the base to be moved horizontally, at least one elevating mechanism having two interconnected zigzag linkages of rods, which is expandable and shrinkable by moving the movable unit to which the bottom of one interconnected zigzag linkage is rotatably connected toward the base to which the bottom of the other interconnected zigzag linkage is rotatably connected an elevating plate which is provided to two tops of the interconnected zigzag linkage, and on which a cassette is put, and a driving unit horizontally moving the movable unit over a predetermined distance.

According to another aspect of the present invention, there is provided a chip sorter, including a working table on which a wafer is put, X and Y driving units horizontally moving the working table at a predetermined position, a wafer cassette elevating apparatus provided to be positioned under a working area “A” of the working table to move up and down a cassette containing the wafer, including a base, a movable unit provided to the base to be moved horizontally, at least one elevating mechanism having two interconnected zigzag linkages of rods, which is expandable and shrinkable by moving the moving unit to which the bottom of one interconnected zigzag linkage is rotatably connected toward the base to which the bottom of the other interconnected zigzag linkage is rotatably connected an elevating plate which is provided to two tops of the interconnected zigzag linkage, and on which the cassette is put, and a driving unit horizontally moving the moving unit over a predetermined distance, a wafer transferring unit transferring the wafer from the cassette to the working table, a carrier containing a chip transferred from the working table, and a picker transferring the chip from the working table to the carrier.

The configuration of the chip sorter according to the present invention enables the working table to be moved to be positioned above the cassette placed on a wafer cassette elevating apparatus. This makes it possible to perform the operation of sorting the chip with the wafer cassette elevating apparatus positioned under the working table, thus reducing the size of the chip sorter.

A distance which the wafer cassette elevating apparatus travels is greater than that which the moving unit travels. This makes it to speed up the upward and downward movement of the wafer cassette elevating apparatus, thus increasing production productivity.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic top view of a conventional chip sorter for separating a wafer into individual chips and transferring the individual chips to a tray;

FIG. 2 is a lateral view of FIG. 1;

FIG. 3 is a perspective view showing a configuration of a chip sorter according to the present invention;

FIG. 4 is a schematic top view showing the chip sorter of FIG. 3;

FIG. 5 is a schematic lateral view showing the chip sorter of FIG. 3;

FIG. 6 is a perspective view showing a configuration of an embodiment of a cassette elevating apparatus which is provided to the chip sorter;

FIG. 7 is a lateral view of the cassette elevating apparatus of FIG. 6; and

FIG. 8 is a top view of the cassette elevating apparatus from which the cassette is removed.

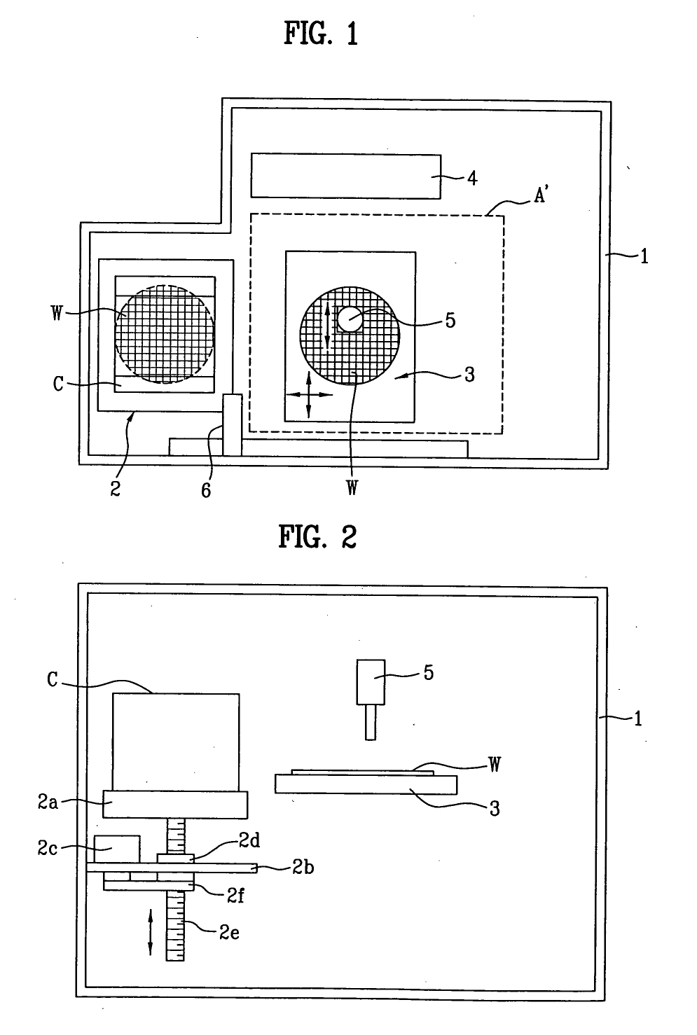

### DETAILED DESCRIPTION OF THE INVENTION

Reference will now be made in detail to the preferred embodiment of the present invention, an example of which is illustrated in the accompanying drawings.

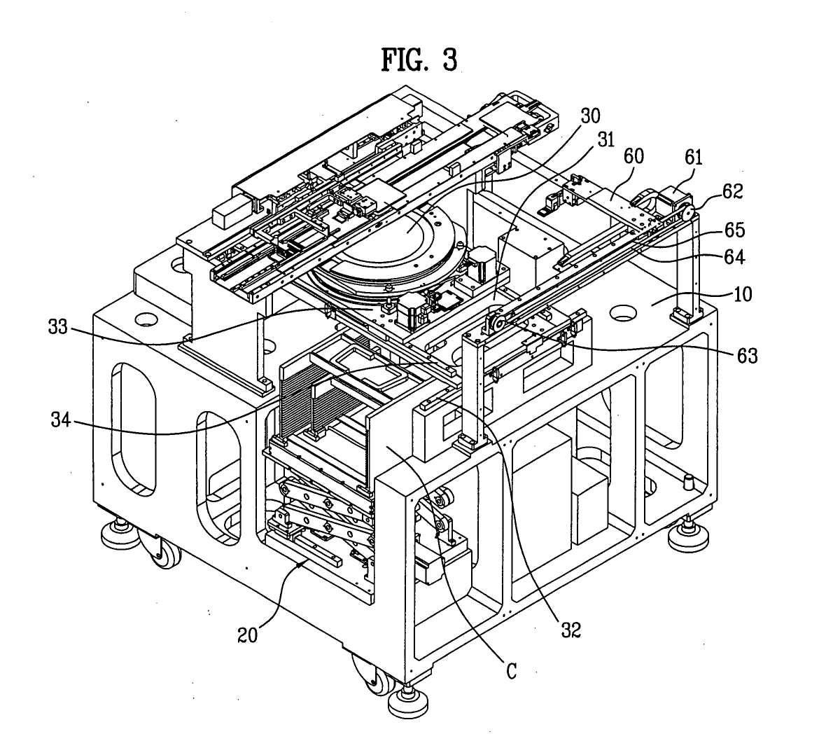

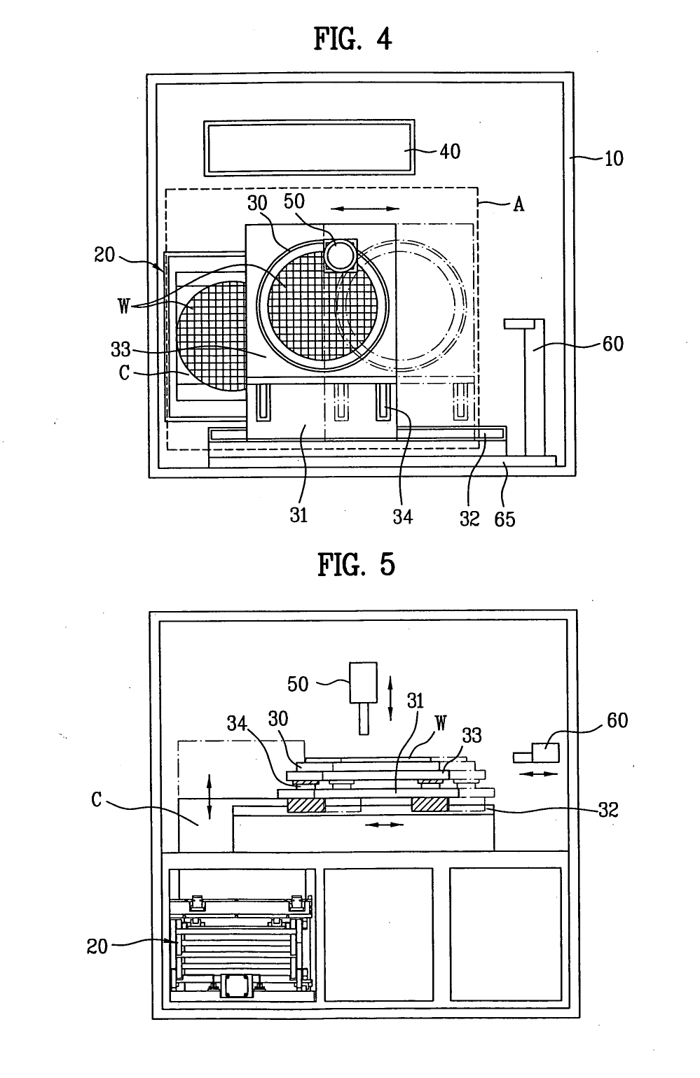

AS shown in FIGS. 3 through 5, the chip sorter according to the present invention includes a body 10, a cassette elevating apparatus 20 provided to one side of the body 10 to move up and down a cassette containing wafers, a working table 30 on which to put the wafer transferred from the cassette elevating apparatus 20, a wafer transferring unit 60 transferring the wafer from the cassette “C” to the working table, a tray containing the wafer transferred from the working table 30, and a picker 50 absorbing a chip in wafer form on the working table and transferring the chip to the tray 40.

The working table 30 is provided to an Y-axis movable plate 33. The Y-axis movable plate 33 is provided to an Y-axis guide rail 34 extending in an Y-axis direction with respect to an X-axis movable plate 31 to be moved along the Y-axis guide rail 34. The X-axis movable 31 is provided to an X-axis guide rail 32 extending in an X-axis direction with respect to the body 10 to be moved along the X-axis guide rail 32.

The X-axis movable plate 31 and the Y-axis movable plate 33 are moved to be positioned over a predetermined distance by X and Y driving units (not shown) including a linear movement unit including a motor, pulleys, and a belt, and a linear movement unit including a linear motor, a ball screw, and a motor. A quadrangle area where the working table 3 can travel farthest in the X and Y directions is defined as a working area “A” which is shown as a dotted line in FIG. 3.

The cassette elevating apparatus 20 is provided to be moved up and down under the working area “C” of the working table “C.”

The working table 30, when the cassette elevating apparatus 20 moves down the cassette “C” to the utmost, is moved in the X and Y directions within the working area “A” to perform the chip sorting operation. The working table 30, when the cassette elevating apparatus 20 moves up the cassette “C”, is moved toward the side of the cassette to prevent the upward movement of the cassette.

The picker 50 continues to travel back and forth from a given point on the working table 30 to a given point on the tray 40 to transfer the chip on the wafer.

The wafer transfer unit 60 is provided to an upper side of the body 10. The wafer transferring unit 60 is moved back and forth horizontally in the X-axis direction to move the wafer from the cassette “C” to the working table 30. Reference numerals 61, 62, 63 in FIG. 3 indicate a motor, a main pulley 62 to be driven by the motor 61, and a dependent pulley 63 receiving driving force with a belt 64, respectively. A reference numeral 65 indicates a guide rail guiding a movement of a wafer cassette transferring unit 60. The wafer cassette transferring unit 60 is connected to the belt 64 and thereby moved along the guide rail 65 when the motor 61 is in operation.

The cassette elevating apparatus 20 moves up and down the cassette “C” as the elevating mechanism is expanded and shrank, respectively.

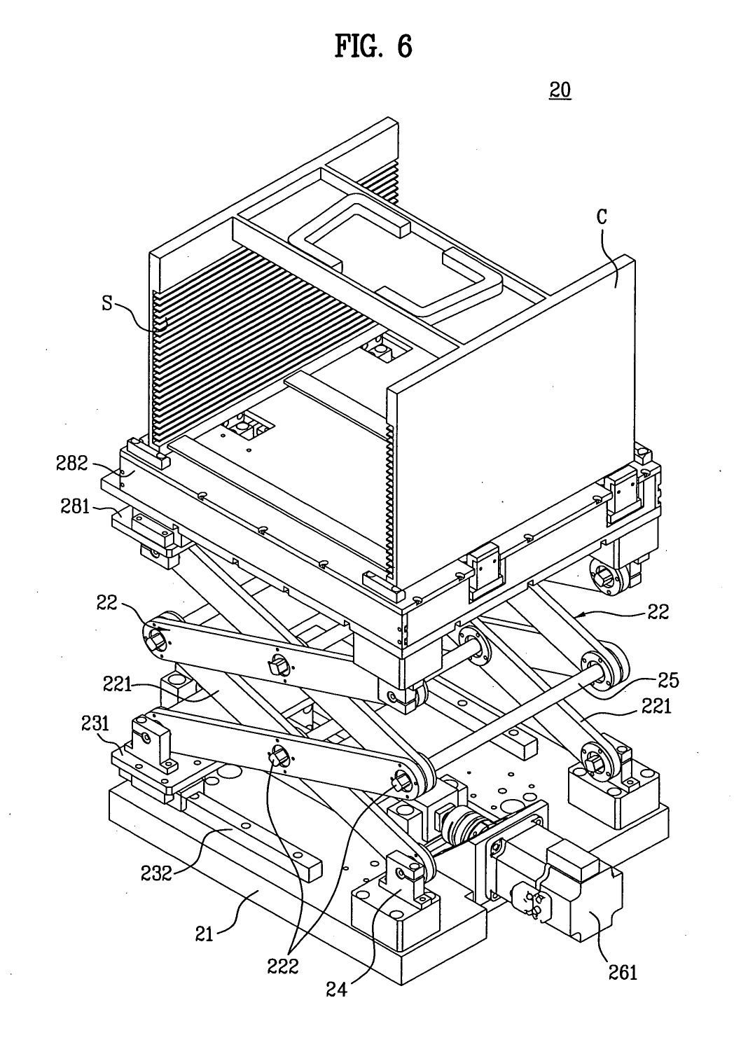

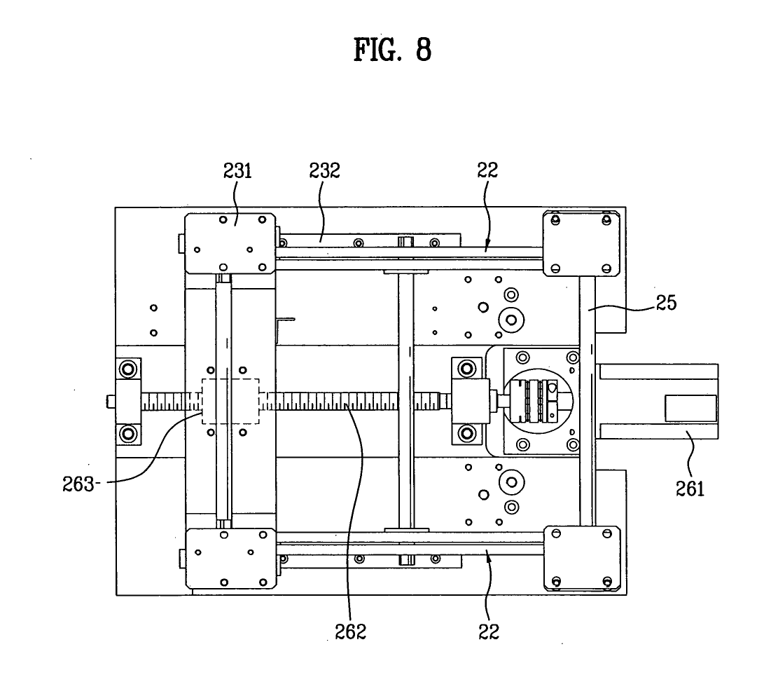

Referring to FIGS. 6 through 8, a configuration of the cassette elevating apparatus 20 is now described in detail.

The cassette elevating apparatus 20 includes the base 21 fixed to the lower side of the body 10 as shown in FIG. 3 and two elevating mechanisms 22 provided to the base 21 to be opposed to each other

A bracket 24 is provided to one end of the base 21. The movable block 231 is provided to the other end of the base 21 to be moved horizontally along the guide rail 232. Each of the elevating mechanisms 22 has two interconnected zigzag linkages of rods 221. The bottom of one interconnected zigzag linkage is rotatably connected to the bracket 24. The bottom of the other interconnected zigzag linkage is rotatably connected to the movable block 231. In this embodiment, each of the elevating mechanism includes two interconnected zigzag linkages, each having two rods 221.

A bracket 281 is fixed to each of the elevating mechanisms. An elevating plate 282, on which the cassette C is put, is provided to the bracket 281. The cassette “C” is box-shaped, of which the lateral sides have openings. Slots “S”, by which the wafer is supported, are provided to the inside lateral surfaces of the cassette “C”.

The pivot points 222 of the rods in one elevating mechanism 22 may be connected to those of the other elevating mechanism 22 with a connecting shaft 25 to support the weight of the cassette “C”.

The movable block 231 is moved along the guide rail 232 over a predetermined distance by the linear movement unit provided to the base 21. The linear movement unit according to the embodiment of the present invention, a ball screw 262 provided in parallel to the guide rail 232 to the base 21, a nut 263 of which the upper side is connected to the movable block 231, which is moved along the ball screw 262 by rotation of the ball screw 262, and a servomotor 261 rotating the ball screw 262.

The linear movement unit including a linear motor, or the linear movement unit including a motor, a pulley, and a belt may be employed to move the movable block 231.

The operation of the cassette elevating apparatus 20 having the above configuration is now described in detail.

The servomotor 261, when receiving a signal to move up the cassette from outside, rotates the ball screw 262 in one direction. The rotation of the ball screw 262 enables the nut 263 to be moved along the ball screw 262. Thus, the movable block 231 is moved along the guide rail toward the bracket 24.

When the movable block 231 is moved toward the bracket 24, the rods 221 rotates in a upward direction about the pivot points 222 to move up the elevating mechanism. Thus, the cassette C is moved up.

The servomotor 261, when receiving a signal to move down the cassette from outside, rotates the ball screw 262 in the opposite direction. When the movable block 231 is moved away form the bracket 24, the rods 221 rotates in a downward direction about the pivot points 222 to move down the elevating mechanism. Thus, the cassette C is moved down.

The cassette elevating apparatus 20 moves up and down the cassette “C” by expanding and shrinking the elevating mechanisms 22. At this point, the distance which the cassette “C” travels is much greater than that which the movable block 231 travels.

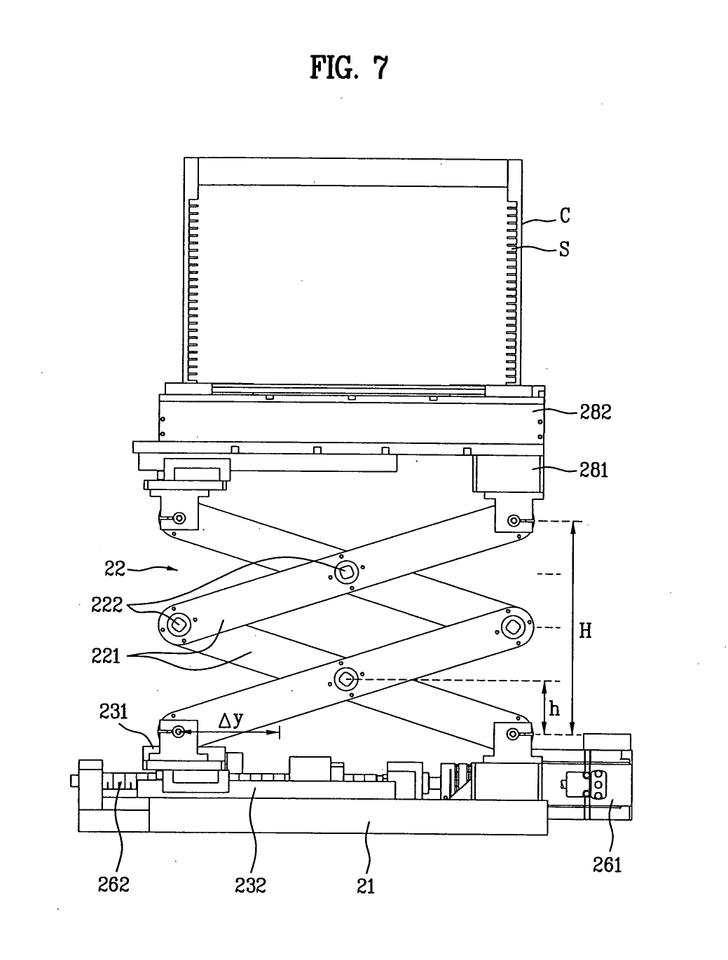

Referring to FIG. 7, a relationship between the distances traveled by the cassette “C” and the movable block 231 is now described in detail. For ease of explanation, assume that the vertical distance between the top connection point of the mechanism 22 and the bottom connection point of the mechanism 22 is “H,” and the distance between the bottom connection point of the mechanism 22 and the first pivoting point is “h”. Then we get “H=4h”.

The distance which the movable block 231 travels is defined as “Δy” An amount of change in the distance between two pivot points of rods is defined as “h”. An amount of change in the vertical distance between the top connection point of the mechanism 22 and the bottom connection point of the mechanism 22 is defined as “ΔH”.

When the movable block 231 is moved by “Δy”, “h” is changed by “Δh”. Then, we also get “ΔH=4×Δh”. That is, when the movable block 231 is moved by “Δy”, a height of the cassette is changed by “4Δy”.

The height of the cassette “C” is enabled to be changed largely in proportion to the distance which the movable block 231 travels. This makes it possible to increase the amount of change in the height of the cassette “C” without accordingly increasing a whole size of the cassette elevating apparatus 20.

The operation of the chip sorter according to the present invention is now described in detail.

The control signal is applied to the servomotor 261 of the cassette elevating apparatus 20, when the cassette “C” containing the wafers “W” is put on the elevating plate 282 and the chip sorter is in operation. The servomotor 261 rotates the ball screw 262, thus moving the movable block 231. This enables the elevating mechanism to expand upward, thus moving up the cassette “C” at the predetermined height.

The wafer transferring unit 60 is moved along the guide rail 65 to pick out one wafer “W” from the cassette “C” and transfer the wafer to the working table 30.

When the control signal is applied to the servomotor 261 of the cassette elevating apparatus 20, the movable block 231 is moved in the opposite direction, Thus, the elevating mechanism is shrank downward, thus returning the cassette “C” to its original position.

The working table 30 is moved along the X-axis guide rail and positioned above the cassette elevating apparatus 20 by the X and Y driving units (not shown). At this point, the first chip to pick up from the wafer “W” on the working table is positioned just under the picker 50.

The picker 50 descends to absorb the chip in wafer form on the working table 30 and transfer the chip to the tray 50. Thereafter, the picker 50 returns to its original position. While the picker 50 transfers the chip to the try 50, the X and Y driving unit (not shown) moves the X-axis movable plate 31 and/or the Y-axis movable plate 33 to position just under the picker 50 the next chip to pick up. The picker 50 again descends to absorb the chip in wafer form and transfer the chip to the tray 40. Like this, the picker 50 and the working table 30 serve to transfer the chip in wafer form to the tray 40.

The X-axis movable table 31 of the working table 30, when finishing transferring all the chips in wafer form, is moved along the X-axis guide rail 32 toward the side of the cassette by the X and Y driving units to provide space necessary to move up the cassette “C”.

The cassette “C” is moved up, when the control signal is applied to the servomotor 261 of the cassette elevating apparatus 20. The wafer transferring unit 60 is moved toward the cassette “C” and picks out the wafer from the wafer “W” to transfer the wafer to the working table 30.

As above described, the cassette elevating apparatus 20 returns the cassette “C” to its original position. The working table 30 is moved to the location under which the cassette elevating apparatus 20 is positioned. The picker 50 transfers the wafer on the working table 30 to the tray 40.

A part of the cassette elevating apparatus 20, instead of the whole of cassette elevating apparatus 20, may be positioned within the working area “A” of the working table 30.

The cassette elevating apparatus 20 according to the present invention may be employed in whatever type of apparatus which picks out the wafer from the cassette and transfers the wafer to perform a specific function.

The position of the working table over the cassette of the cassette elevating apparatus can largely reduce the size of the chip sorter. The cassette's traveled distance large in proportion to the movable unit's traveled distance can speed up the upward and downward movement of the cassette.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A wafer cassette elevating apparatus, comprising:
a base;
a movable unit provided to the base to be moved horizontally;
at least one elevating mechanism having two interconnected zigzag linkages of rods, which is expandable and shrinkable by moving the movable unit to which the bottom of one interconnected zigzag linkage is rotatably connected toward the base to which the bottom of the other interconnected zigzag linkage is rotatably connected;
an elevating plate which is provided to two tops of the interconnected zigzag linkage, and on which a cassette is put; and
a driving unit horizontally moving the movable unit over a predetermined distance.

2. The wafer cassette elevating apparatus according to claim 1, wherein the elevating mechanism comprises a first elevating mechanism and a second elevating mechanism opposed to each other, which are provided to the base .

3. The wafer cassette elevating apparatus according to claim 2, further comprising a plurality of connecting shafts connecting a plurality of pivot points of the rods in the first elevating mechanism to a plurality of pivot points of the rods in the second elevating mechanism, with the connecting shafts being in parallel to each other.

4. The wafer cassette elevating apparatus according to claim 1, wherein the movable unit comprises a guide rail provided to the base in a direction of the width of the elevating mechanism and a movable block moving along the guide rail.

5. The wafer cassette elevating apparatus according to claim 1, wherein the driving unit comprises a ball screw provided to the base in a moving direction of the movable unit, a nut of which one side is connected to the movable unit, which is moved along the ball screw by rotation of the ball screw, and a motor rotating the ball screw.

6. A chip sorter comprising:
a working table on which a wafer is put;
X and Y driving units horizontally moving the working table at a predetermined position;
a wafer cassette elevating apparatus provided to be positioned under a working area of the working table to move up and down a cassette containing the wafer, comprising a base, a movable unit provided to the base to be moved horizontally, at least one elevating mechanism having two interconnected zigzag linkages of rods, which is expandable and shrinkable by moving the moving unit to which the bottom of one interconnected zigzag linkage is rotatably connected toward the base to which the bottom of the other interconnected zigzag linkage is rotatably connected; an elevating plate which is provided to two tops of the interconnected zigzag linkage, and on which the cassette is put, and a driving unit horizontally moving the moving unit over a predetermined distance;
a wafer transferring unit transferring the wafer from the cassette to the working table; and
a carrier containing a chip transferred from the working table, and a picker transferring the chip from the working table to the carrier.

7. The chip sorter according to claim 1, wherein the whole of the cassette elevating apparatus is positioned within the working area of the working table.

8. The chip sorter according to claim 1, wherein a part of the cassette elevating apparatus is positioned within the working area of the working table.

9. The chip sorter according to claim 6, wherein the elevating mechanism comprises a first elevating mechanism and a second elevating mechanism opposed to each other, which are provided to the base.

10. The chip sorter according to claim 6, further comprising a plurality of connecting shafts connecting a plurality of pivot points of the rods in the first elevating mechanism to a plurality of pivot points of the rods in the second elevating mechanism, with the connecting shafts being in parallel to each other.

11. The chip sorter according to claim 6, wherein the movable unit comprises a guide rail provided to the base in a direction of the width of the elevating mechanism and a movable block moving along the guide rail.

12. The chip sorter according to claim 6, wherein the driving unit comprises a ball screw provided to the base in a moving direction of the movable unit, a nut of which one side is connected to the movable unit, which is moved along the ball screw by rotation of the ball screw, and a motor rotating the ball screw.
